(19) United States
(12) Patent Application Publication
(10) Pub. No.: US 2020/0133105 A1
(43) Pub. Date: Apr. 30, 2020

(54) MIRROR DRIVE DEVICE, AND IMAGE PICKUP APPARATUS EQUIPPED WITH MIRROR DRIVE DEVICE

(71) Applicant: CANON KABUSHIKI KAISHA, Tokyo (JP)

(72) Inventor: Natsu Mikami, Kawasaki-shi (JP)

(21) Appl. No.: 16/660,025

(22) Filed: Oct. 22, 2019

(30) Foreign Application Priority Data
Oct. 25, 2018 (JP) 2018-200948

(51) Int. Cl. G03B 19/12; G03B 17/12; G02B 26/08

(52) U.S. Cl. CPC G03B 19/12; G03B 2217/002; G02B 26/08; G03B 17/12

(57) ABSTRACT

A mirror drive device that hardly causes a delay of drive of a second mirror with respect to control for a first mirror and enables stable drive. A first holding member holds a first mirror. A supporting member rotatably supports the first holding member. A second holding member holds a second mirror and is rotatably supported by the first holding member. A drive member is rotatably supported by the supporting member and is rotatably connected with the second holding member. Rotation of one of the first holding member and the second holding member interlocks with rotation of the other through rotation of the drive member.

### BACKGROUND OF THE INVENTION

### Field of the Invention

The present invention relates to a mirror drive device and an image pickup apparatus equipped with the mirror drive device.

### Description of the Related Art

Some of single-lens reflex cameras are provided with a mirror drive device that has a main mirror that reflects an incident light beam toward a finder optical system and a sub mirror that guides a part of the incident light beam that is transmitted through the main mirror to a focus detection device. The mirrors stop at respective predetermined positions that obstruct a photographing light path by contacting stoppers provided in a mirror box in a camera body before photographing so as to guide the incident light beam to the finder optical system and the focus detection device. In the meantime, a mirror driving mechanism retracts the mirrors outside the photographing light path (a mirror-up action) at a time of photographing and returns the mirrors to the predetermined positions in the photographing light path (a mirror-down action) after photographing.

Such a mirror driving mechanism is required to reduce a bound (hereinafter referred to as a “mirror bound”) that occurs when the mirrors collide with the respective stoppers at the time of the mirror-down action. This is because reduction of the bound of the main mirror stabilizes a finder image promptly and reduction of the bound of the sub mirror enables rapid start of the focus detection. Moreover, shortening of a period from occurrence of the mirror bound to convergence is able to improve a continuous photographing speed.

In order to solve such a problem, Japanese Patent No. 6160312 discloses a mirror drive device that is equipped with an interlocking lever that interlocks a sub mirror with a main mirror. A bound of the sub mirror is reduced by restricting rotation of the interlocking lever using a damping member that rotates by interlocking with a main-mirror holder.

However, the technique disclosed in the above-mentioned patent causes a delay of the drive of the sub mirror to the control for main mirror because a connection part of the interlocking lever with a sub-mirror holder is a long hole. As a result, the mirror bound occurs when the sub mirror collides with the stopper in the mirror-down action to return the mirrors into the photographing light path. Moreover, since energization force of a spring that energizes the interlocking lever has to be decreased after being increased once during a series of the mirror-up action and the mirror-down action, load fluctuation becomes large and the drive is not stabilized.

### SUMMARY OF THE INVENTION

The present invention provides a mirror drive device that hardly causes a delay of drive of a second mirror (sub mirror) with respect to control for a first mirror (main mirror) and enables stable drive.

Accordingly, a first aspect of the present invention provides a mirror drive device including a first holding member that holds a first mirror, a supporting member that rotatably supports the first holding member, a second holding member that holds a second mirror and is rotatably supported by the first holding member, and a drive member that is rotatably supported by the supporting member and is rotatably connected with the second holding member. Rotation of one of the first holding member and the second holding member interlocks with rotation of the other through rotation of the drive member.

Accordingly, a second aspect of the present invention provides a mirror drive device including a first holding member that holds a first mirror, a supporting member that rotatably supports the first holding member, a second holding member that holds a second mirror and is rotatably supported by the first holding member, an energization member that is rotatably supported by the support member, a drive member that is rotatably connected to the energization member and is rotatably connected with the second holding member, and a restriction part that is provided in the support member and restricts a rotatable range of the energization member. The energization member is energized in one of two rotatable directions. Rotation of one of the first holding member and the second holding member interlocks with rotation of the other through rotation of the drive member.

Accordingly, a third aspect of the present invention provides an image pickup apparatus including a focus detection sensor, an optical finder, a mirror unit that is provided with a first mirror that reflects a light beam entered through a photographing optical system to the optical finder and a second mirror that reflects a light beam transmitted through the first mirror toward the focus detection sensor, and the mirror drive device according to the first aspect.

Accordingly, a fourth aspect of the present invention provides an image pickup apparatus including a focus detection sensor, an optical finder, a mirror unit that is provided with a first mirror that reflects a light beam entered through a photographing optical system to the optical finder and a second mirror that reflects a light beam transmitted through the first mirror toward the focus detection sensor, and the mirror drive device according to the second aspect.

The present invention achieves the mirror drive device that hardly causes a delay of the drive of the second mirror with respect to the control for the first mirror and that enables stable drive.

Further features of the present invention will become apparent from the following description of exemplary embodiments with reference to the attached drawings.

### BRIEF DESCRIPTION OF THE DRAWINGS

FIG. 1A and FIG. 1B are sectional views showing a schematic configuration of an image pickup apparatus according to embodiments of the present invention.

FIG. 2A and FIG. 2B are respectively a front view and a right side view showing a mirror drive device according to a first embodiment.

FIG. 3 is an exploded perspective view showing the mirror drive device according to the first embodiment.

FIG. 4A and FIG. 4B are side views for describing a configuration of a mirror unit in the first embodiment.

FIG. 5A and FIG. 5B are respectively a front view and a right side views showing a mirror drive device according to a second embodiment.

FIG. 6 is an exploded perspective view showing the mirror drive device according to the second embodiment.

FIG. 7A and FIG. 7B are side views for describing a rotatable range of a sub-mirror holder in the second embodiment.

FIG. 8 is a right side view showing a mirror-down state of a mirror unit in the second embodiment.

FIG. 9 is a right side view showing a state during transition of the mirror unit from a mirror-down position to a minor-up position in the second embodiment.

FIG. 10 is a right side view showing the mirror-up state of the mirror unit in the second embodiment.

FIG. 11 is a right side view showing the mirror-down state and mirror-up state of the mirror unit in the second embodiment in an overlapped fashion.

### DESCRIPTION OF THE EMBODIMENTS

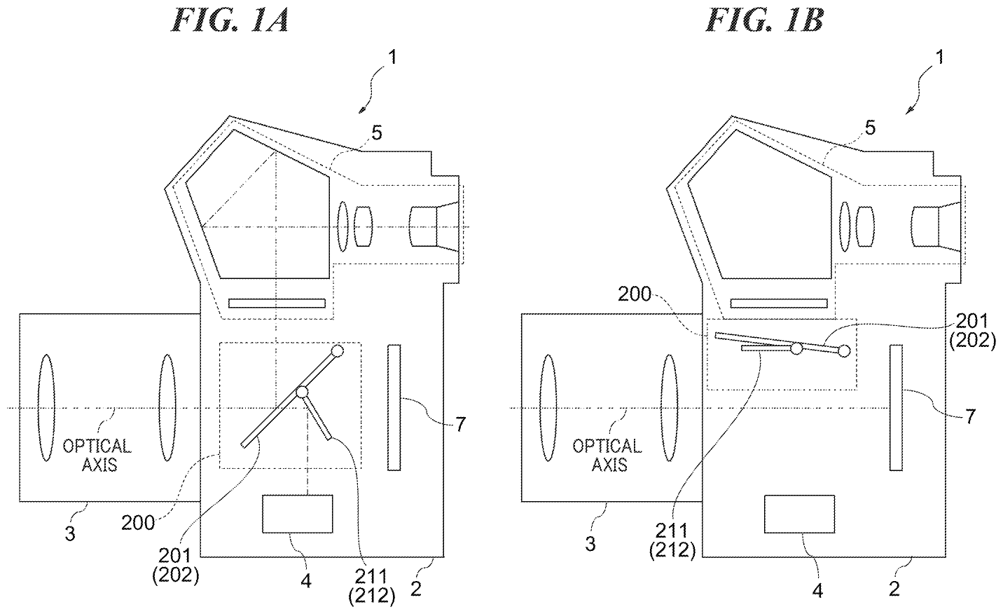

Hereafter, embodiments according to the present invention will be described in detail by referring to the drawings. First, an entire configuration that is common to image pickup apparatuses according to first and second embodiments mentioned later will be described by referring to FIG. 1A and FIG. 1B.

FIG. 1A is a sectional view showing a schematic configuration of the image pickup apparatus 1 according to the embodiment of the present invention and shows a state where a main mirror (first mirror) 201 and a sub mirror (second mirror) 211 are in mirror-down positions. FIG. 1B is a sectional view showing the schematic configuration of the image pickup apparatus 1 and shows a state where the main mirror 201 and the sub mirror 211 are in mirror-up positions.

Specifically, the image pickup apparatus 1 is a digital single lens reflex camera, and has a camera body 2 and an interchangeable lens (lens barrel) 3 that is detachable to the camera body 2. The camera body 2 is provided with a focus detection unit 4, an optical finder unit 5, a mirror unit 200, and an image sensor 7.

The mirror unit 200 is one of components of a mirror drive device. The mirror unit 200 has the main mirror 201 and a main-mirror holder (first holding member) 202 that holds the main mirror 201. Moreover, the mirror unit 200 has a sub mirror 211 and a sub-mirror holder (second holding member) 212 that holds the sub mirror 211.

The main mirror 201 employs a half minor. The main-mirror holder 202 and sub-mirror holder 212 are rotatably attached to a minor box (support member) that is not shown. A mirror driving mechanism (not shown) rotates the main mirror 201 (main-mirror holder 202) between a mirror-down position (first position) in FIG. 1A and a minor-up position (second position) in FIG. 1B. In connection with the rotation of the main-minor holder 202, the sub mirror 211 (sub-minor holder 212) is rotated between a mirror-down position (third position) and a minor-up position (position of a fourth).

The state where both the main mirror 201 and sub mirror 211 are in the mirror-down positions as shown in FIG. 1A will be described as “the minor unit 200 is in a mirror-down state” in the following description. When the mirror unit 200 is in the mirror-down state, the main mirror 201 and sub mirror 211 are held at predetermined positions in a photographing light path. In this state, an incident light beam passing through the interchangeable lens 3 is divided by the main mirror 201. A part of the incident light beam that is reflected by the main mirror 201 is guided to a pentagonal prism of the optical finder unit 5. In the meantime, the light beam transmitted through the main mirror 201 is guided to the sub mirror 211, and then reflected by the sub mirror 211 toward the focus detection unit 4. Accordingly, when the mirror unit 200 is in the mirror-down position, the incident light beam which passed the interchangeable lens 3 is not guided to the image sensor 7.

The state where both the main mirror 201 and sub mirror 211 are in the mirror-up positions as shown in FIG. 1B will be described as “the mirror unit 200 is in a mirror-up state” in the following description. When the mirror unit 200 is in the mirror-up state, the main mirror 201 and sub mirror 211 are retracted from the photographing light path (above the photographing light path). At this time, the main-mirror holder 202 and sub-minor holder 212 move upward in an overlapped state. In this state, the incident light beam passing through the interchangeable lens 3 is guided to the image sensor 7 and forms an image on the image sensor 7 without being guided to the optical finder unit 5 and the focus detection unit 4.

The mirror drive device moves the mirror unit 200 between the mirror-down state and mirror-up state in this way. When the main mirror 201 and sub mirror 211 are in the mirror-down positions, respectively, the main-minor holder 202 and sub-mirror holder 212 are also in the mirror-down positions. Moreover, when the main mirror 201 and sub mirror 211 are in the mirror-up positions, respectively, the main-minor holder 202 and sub-mirror holder 212 are also in the mirror-up positions. Then, the mirror drive device does not directly drive the main mirror 201 and sub mirror 211 but rotates the main mirror 201 and sub mirror 211 by driving the main-mirror holder 202 and sub-mirror holder 212. Accordingly, a rotation and position of each mirror will be described using a drive and position of each mirror holder suitably in the following description.

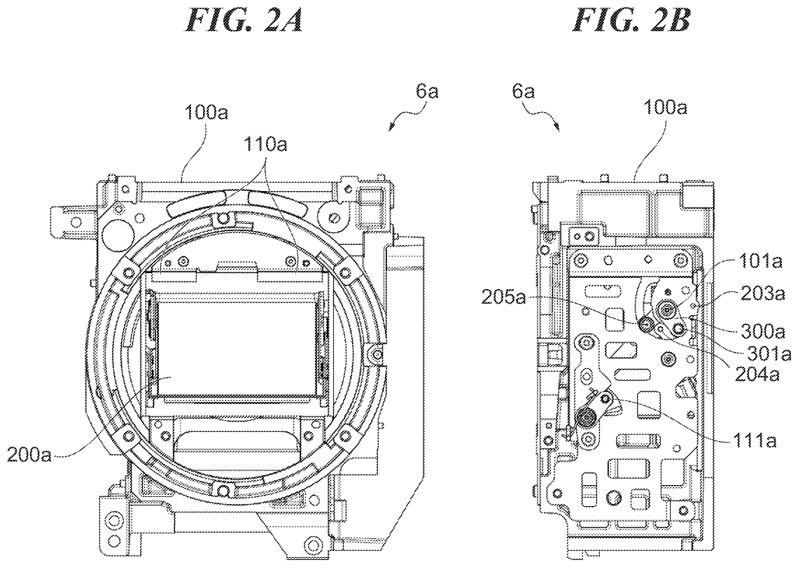

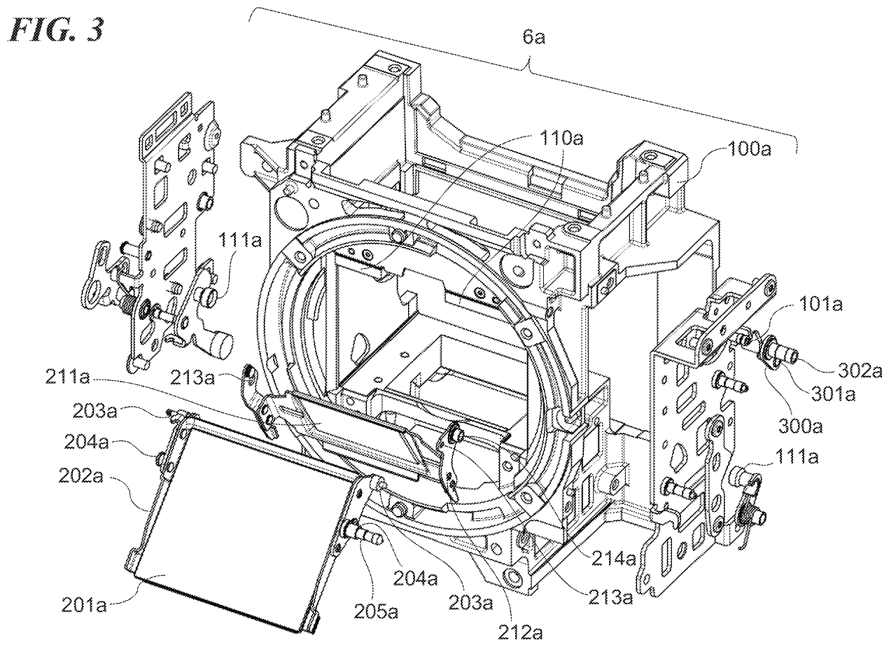

FIG. 2A is a front view showing a schematic configuration of a mirror drive device 6a according to a first embodiment. FIG. 2B is a right side view showing the schematic configuration of the mirror drive device 6a. It should be noted that the right side of the mirror drive device 6a is defined when the mirror drive device 6a is viewed from the front (the right side in FIG. 2A). FIG. 3 is an exploded perspective view showing the schematic configuration of the mirror drive device 6a.

It should be noted that a reference numeral that is configured to add ‘a’ to a reference numeral applied to a component of the mirror drive device described by referring to FIG. 1A and FIG. 1B shall be applied to the corresponding component in the first embodiment. For example, a mirror unit, main mirror, and sub mirror are respectively denoted by reference numerals 200a, 201a and 211a. It should be noted that the mirror drive device 6a provides mechanisms that drive the mirror unit 200a at both of left and right sides of the mirror box 100a as shown in FIG. 3. Since the mechanisms have almost the same configuration, the right side mechanism is mainly described.

The mirror drive device 6a is provided with a mirror box 100a, mirror unit 200a and sub-minor drive member 300a. The mirror unit 200a is provided with the main mirror 201a a main-minor holder 202a, the sub minor 211a and a sub-mirror holder 212a. The main mirror 201a is held by the main-mirror holder 202a, and the sub mirror 211a is held by the sub-mirror holder 212a.

The main-minor holder 202a has a main-mirror rotation shaft 203a, sub-mirror supporting shaft 204a, and main-mirror drive shaft 205a. The main-mirror holder 202a is rotatably supported by the mirror box 100a with the main-mirror rotation shaft 203a so as to be rotatable between the mirror-down position and mirror-up position around the main-mirror rotation shaft 203a as a rotation center. The sub-mirror holder 212a has a sub-minor rotation hole 213a and sub-mirror drive hole 214a. The sub-mirror holder 212a is rotatably supported by the main-minor holder 202a by fitting the sub-minor supporting shaft 204a of the main-minor holder 202a into the sub-mirror rotation hole 213a.

The sub-mirror drive member 300a has a sub-minor drive shaft 301a and connecting sleeve 302a. The sub-minor drive member 300a is rotatably supported by the mirror box 100a by fitting a shaft 101a formed on the mirror box 100a into the connecting sleeve 302a. Moreover, the sub-mirror drive member 300a is rotatably connected with the sub-mirror holder 212a by fitting the sub-mirror drive shaft 301a into the sub-mirror drive hole 214a.

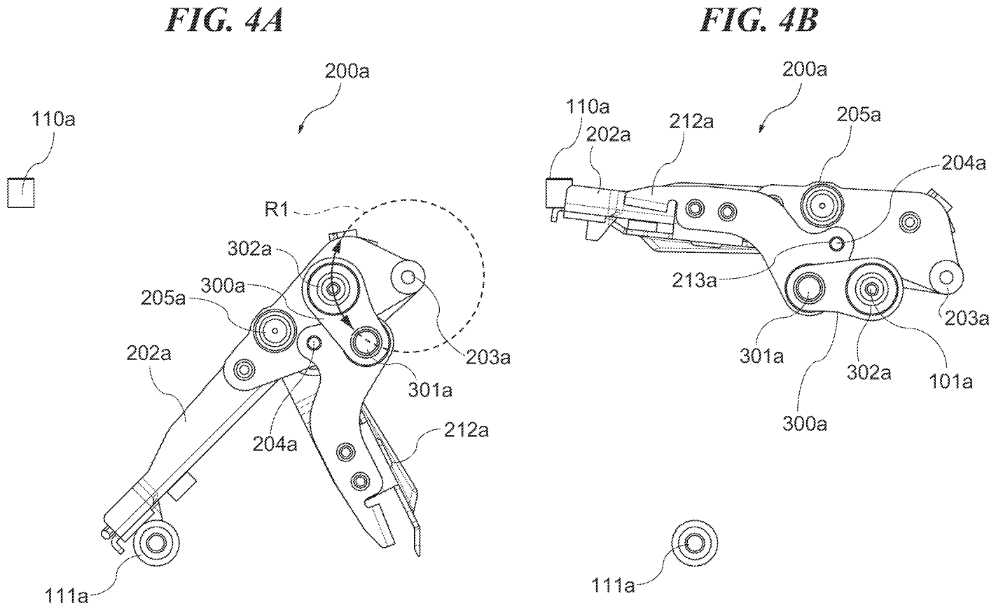

Hereinafter, the configuration of the mirror drive device 6a will be further described by referring to FIG. 4A and FIG. 4B in addition to FIG. 2A, FIG. 2B, and FIG. 3. FIG. 4A is a right side view when the mirror unit 200a is in the mirror-down state. FIG. 4B is a right side view when the mirror unit 200a is in the mirror-up state.

A main-mirror drive mechanism (not shown) is arranged at the right side of the mirror box 100a when the mirror box 100a is viewed from the front. The main-mirror drive mechanism is able to employ a well-known mechanism (including a mirror drive lever unit and motor unit) that is disclosed in Japanese Laid-Open Patent Publication (Kokai) No. 2017-40828 (JP 2017-40828A), for example.

When the mirror unit 200a is in the mirror-down state, the main-mirror holder 202a is energized by the main-minor drive mechanism in the mirror-down direction around the main-mirror rotation shaft 203a. Main-minor stoppers 111a are provided in the right and left of the mirror box 100a. The main-minor holder 202a is held at the mirror-down position because the main-mirror holder 202a is energized in the minor-down direction and contacts the main-mirror stoppers 111a. In the meantime, the position of the sub-minor holder 212a is decided by the sub-mirror supporting shaft 204a of the main-mirror holder 202a and the sub-minor drive shaft 301a of the sub-minor drive member 300a. Accordingly, when the main mirror 201a is at the mirror-down position, the sub mirror 211a is also held at the mirror-down position.

When the mirror unit 200a is in the minor-up state, the main-mirror holder 202a is energized by the main-minor drive mechanism in the minor-up direction around the main-mirror rotation shaft 203a. Main-minor stoppers 110a are provided in the mirror box 100a. The main-minor holder 202a is held at the mirror-up position because the main-minor holder 202a is energized in the mirror-up direction and contacts the main-minor stoppers 110a. The position of the sub-minor holder 212a is decided by the sub-mirror supporting shaft 204a of the main-mirror holder 202a and the sub-minor drive shaft 301a of the sub-mirror drive member 300a. Thus, when the main mirror 201a is at the minor-up position, the sub mirror 211a is also held at the mirror-up position.

In this way, the mirror drive device 6a is configured so that rotation of one of the main-minor holder 202a and sub-minor holder 212a interlocks with rotation of the other through the sub-mirror drive member 300a. In the mirror drive device 6a, transition of the mirror unit 200a between the mirror-down state (FIG. 4A) and the minor-up state (FIG. 4B) occurs because the main-minor drive mechanism elevates and lowers the main-mirror drive shaft 205a of the main-mirror holder 202a. The drive of the main-mirror holder 202a is controlled by using the mechanism disclosed in Japanese Laid-Open Patent Publication (Kokai) No. 2017-40828 (JP 2017-40828A) mentioned above as the main-mirror drive mechanism.

In the mirror unit 200a, since the position of the sub-minor holder 212a is decided by the sub-mirror supporting shaft 204a and sub-minor drive shaft 301a the drive of the sub-mirror holder 212 is controlled without delay from the drive controlling of the main-minor holder 202a. That is, the mirror bound of the sub-minor holder 212a is reduced by optimizing the drive control so that the mirror bound will not occur when the main-mirror holder 202a stops at the mirror-down position.

In order to guide the incident light beam to the optical finder unit 5 correctly, it is necessary to adjust the positions of the main-mirror stoppers 111a in general so as to adjust the angle of the main mirror 201a with respect to the optical axis at the mirror-down position. The mirror drive device 6a is configured so that the shaft 101a that fits into the connecting sleeve 302a of the sub-minor drive member 300a is fixed to the mirror box 100a. Accordingly, when the mirror-down position of the main-mirror holder 202a is decided, the mirror-down position of the sub-mirror holder 212a is also decided by the sub-mirror drive member 300a. Accordingly, the angle of the sub mirror 211a at the mirror-down position may vary according to the adjustment result of the main mirror 201a. In such a case, the position and posture of the focus detection unit 4 should be adjusted according to the angle of the sub mirror 211a at the mirror-down position.

As compared with this, if the focus detection unit 4 is not adjustable, the shaft 101a should be a different part from the mirror box 100a and the position of the shaft 101a should be adjustable. This enables angle adjustment of the sub mirror 211a. In that case, the position of the shaft 101a is preferably adjustable along a circular arc R1 around the main-mirror rotation shaft 203a shown by a broken line in FIG. 4A. This reduces an influence on the main-mirror drive mechanism because a length relation of a link mechanism that consists of the main-mirror holder 202a, sub-mirror holder 212a, and sub-mirror drive member 300a does not vary even if the position of the shaft 101a is adjusted.

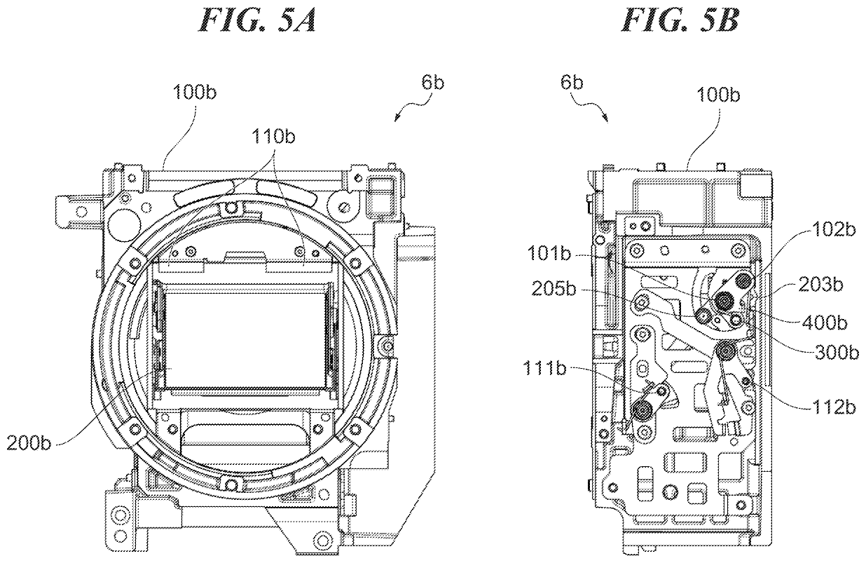

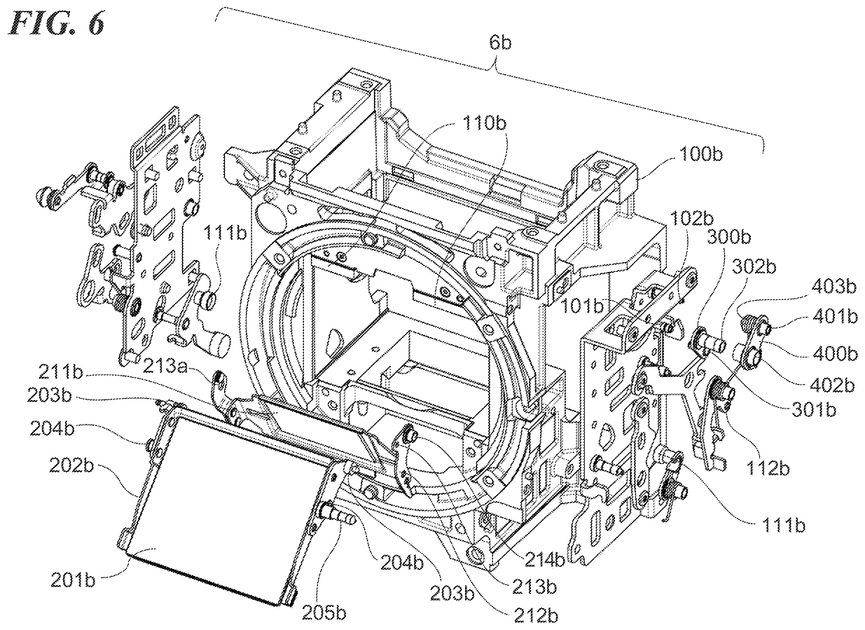

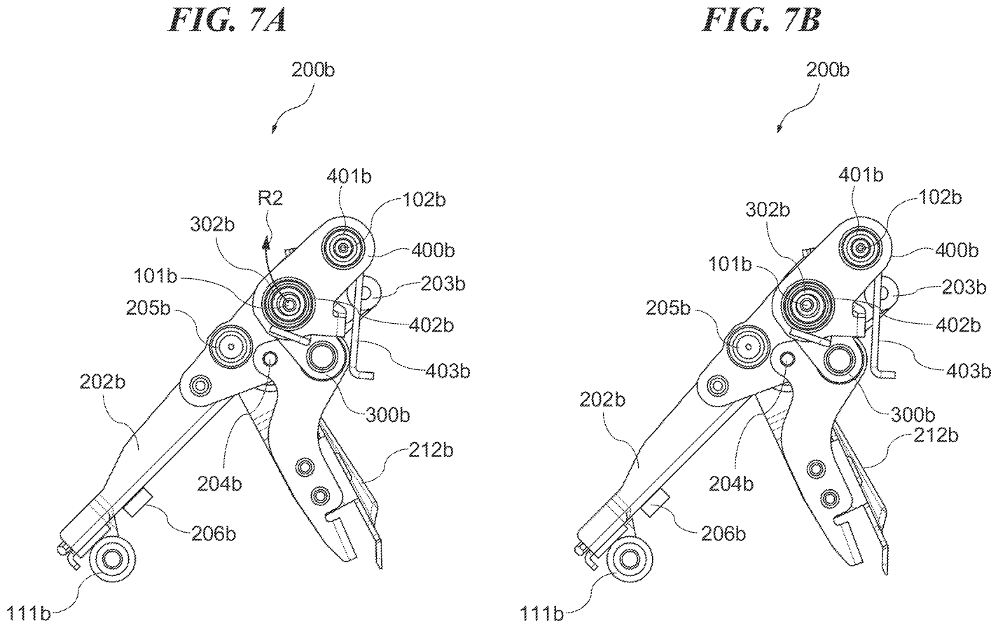

FIG. 5A is a front view showing a schematic configuration of a mirror drive device 6b according to a second embodiment. FIG. 5B is a right side view showing the schematic configuration of the mirror drive device 6b. FIG. 6 is an exploded perspective view showing the schematic configuration of the mirror drive device 6b. FIG. 7A and FIG. 7B are views for describing a rotatable range of a sub-mirror holder 212b at the mirror-down position. It should be noted that a reference numeral that is configured to add ‘b’ to a reference numeral applied to a component of the mirror drive device described by referring to FIG. 1A and FIG. 1B shall be applied to the corresponding component in the second embodiment. For example, a mirror unit, main mirror, and sub mirror are respectively denoted by reference numerals 200b, 201b, and 211b. It should be noted that the mirror drive device 6b provides mechanisms that drive the mirror unit 200b at both of left and right sides of the mirror box 100b as shown in FIG. 6. Since the mechanisms have almost the same configuration, the right side mechanism is mainly described.

The mirror drive device 6b is provided with a mirror box 100b, mirror unit 200b, sub-mirror drive member 300b, and sub-mirror energization member 400b. The mirror unit 200b is provided with the main minor 201b, a main-minor holder 202b, the sub mirror 211b, and a sub-minor holder 212b. The main mirror 201b is held by the main-mirror holder 202b, and the sub mirror 211b is held by the sub-mirror holder 212b.

The main-mirror holder 202b has a main-mirror rotation shaft 203b, sub-mirror supporting shaft 204b, and main-minor drive shaft 205b. The main-minor holder 202b is rotatably supported by the mirror box 100b with the main-minor rotation shaft 203b so as to be rotatable between the mirror-down position and minor-up position around the main-minor rotation shaft 203b as a rotation center. The sub-minor holder 212b has a sub-mirror rotation hole 213b and sub-mirror drive hole 214b. The sub-minor holder 212b is rotatably supported by the main-minor holder 202b by fitting the sub-mirror supporting shaft 204b of the main-mirror holder 202b into the sub-minor rotation hole 213b.

The sub-mirror energization member 400b has a supporting hole 401b, an energization sleeve 402b, and a sub-mirror energization spring 403b. The sub-mirror energization member 400b is rotatably supported by the mirror box 100b by fitting a shaft 102b of the mirror box 100b into the supporting hole 401b. The sub-mirror energization spring 403b has a coil section. The coil section is fitted around a cylindrical pipe constituting the supporting hole 401b of the sub-minor energization member 400b. In such a state, one end of the sub-mirror energization spring 403b is hooked on the energization sleeve 402b and the other end is hooked on the mirror box 100b. The sub-minor energization spring 403b energizes the sub-mirror energization member 400b in a direction indicated by an arrow R2 shown in FIG. 7A around the supporting hole 401b. The arrow R2 direction is the mirror-up direction that is one of the two directions (the minor-up direction and mirror-down direction) in which the sub-minor holder 212b rotates.

The sub-mirror drive member 300b has a sub-mirror drive shaft 301b and a connecting sleeve (a first cylindrical portion) 302b. A restriction part (shaft) 101b formed in the mirror box 100b is inserted into the connecting sleeve 302b. Moreover, the connecting sleeve 302b is slidably fitted into the energization sleeve (a second cylindrical portion) 402b of the sub-mirror energization member 400b. Thereby, the sub-minor drive member 300b is connected to the sub-mirror energization member 400b so as to be rotatable around the energization sleeve 402b. The sub-mirror drive member 300b is rotatably connected with the sub-minor holder 212b by fitting the sub-minor drive shaft 301b into the sub-mirror drive hole 214b.

There is a predetermined backlash (gap) between the inner periphery of the connecting sleeve 302b of the sub-mirror drive member 300b and the outer periphery of the restriction part 101b of the mirror box 100b. The rotatable range of the sub-mirror energization member 400b around the supporting hole 401b is restricted within the limits of the backlash. The sub-mirror holder 212b is movable independently from the main-minor holder 202b within the angular range between the states in FIG. 7A and FIG. 7B.

More specifically, FIG. 7A shows the state where the sub-mirror energization member 400b rotates in the arrow R2 direction and where the connecting sleeve 302b contacts the restriction part 101b. In the meantime, FIG. 7B shows the state where the sub-mirror energization member 400b rotates in the direction opposite to the arrow R2 direction and where the connecting sleeve 302b contacts the restriction part 101b.

The sub-mirror energization spring 403b has a function to cause transition of the mirror unit 200b from the state in FIG. 7B to the state in FIG. 7A by energizing the sub-mirror energization member 400b in the arrow R2 direction. That is, the sub-mirror energization spring 403b plays a role that energizes the sub-mirror holder 212b in the mirror-down direction through the sub-mirror energization member 400b when the sub-mirror holder 212b is at the mirror-down position. The mirror box 100b has a sub-mirror stopper 112b. The sub-mirror holder 212b is energized by the sub-mirror energization spring 403b in the mirror-down direction and the angle of the sub mirror 211b with respect to the optical axis is decided in the state where the sub-minor holder 212b contacts the sub-mirror stopper 112b. Accordingly, the angle of the sub-mirror holder 212b (sub mirror 211b) is adjustable independently from the angle of the main-mirror holder 202b (main minor 201b) by adjusting the position of the sub-mirror stopper 112b in the mirror box 100b.

A main-mirror drive mechanism (not shown) is provided at the right side of the mirror box 100b. A well-known mechanism can be used for the main-minor drive mechanism in the second embodiment as with the first embodiment. As with the mirror drive device 6a, the mirror drive device 6b is configured so that rotation of one of the main-minor holder 202b and sub-mirror holder 212b interlocks with rotation of the other through the sub-mirror drive member 300b. Transition of the mirror unit 200a between the mirror-down state and the mirror-up state occurs because the main-mirror drive mechanism elevates and lowers the main-mirror drive shaft 205b of the main-mirror holder 202b.

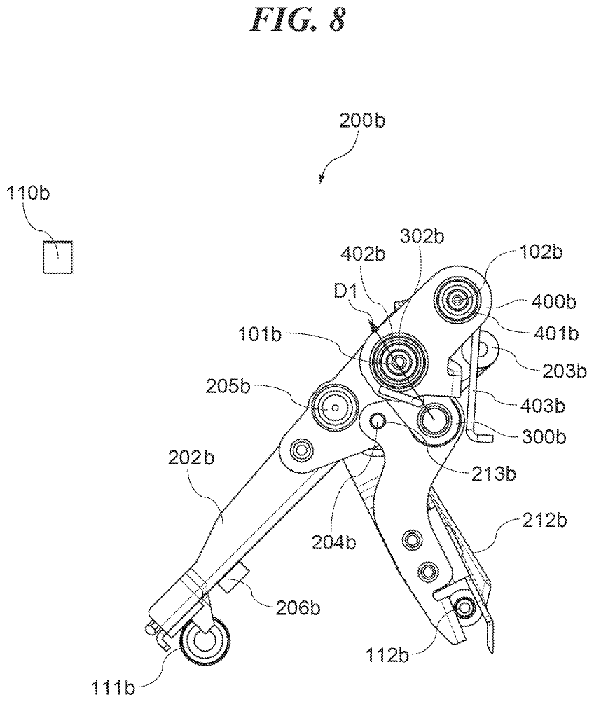

Next, actions of the mirror drive device 6b will be described in detail. FIG. 8 is a right side view showing the mirror unit 200b in the mirror-down state. The main-mirror holder 202b is energized by a main-mirror drive mechanism (not shown) in the mirror-down direction (counterclockwise in FIG. 8) and is held at the mirror-down position by contacting the main-mirror stopper 111b. The sub-mirror holder 212b receives force in a direction of an arrow D1 direction from the sub-mirror drive member 300b that is pulled up by the sub-mirror energization member 400b. The sub-mirror holder 212b is energized in the mirror-down direction (counterclockwise in FIG. 8) around the sub-mirror rotation hole 213b and is held at the mirror-down position by contacting the sub-mirror stopper 111b. At this time, the connecting sleeve 302b of the sub-mirror drive member 300b is not in contact with the restriction part bib of the mirror box 100b.

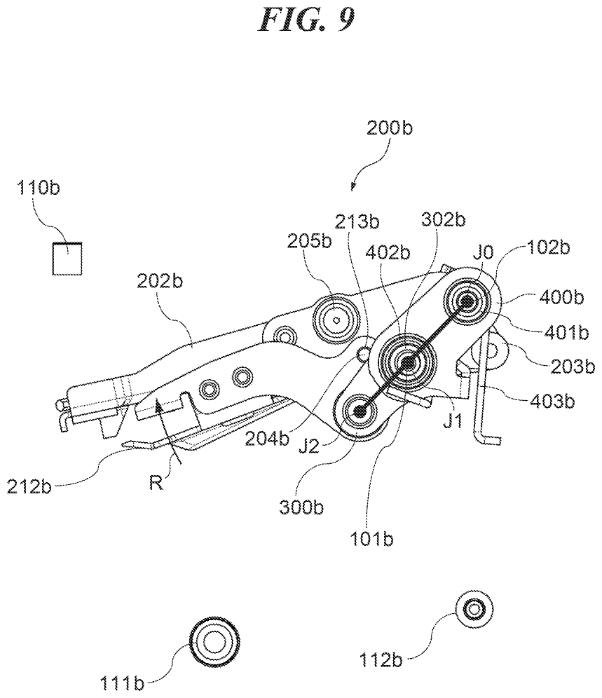

FIG. 9 is a right side view showing a state during transition of the mirror unit 200b from the mirror-down position to the minor-up position. A point J0 in FIG. 9 is a point to which the center line of the shaft 102b (the center line of the rotation of the sub-mirror energization member 400b to the mirror box 100b) is projected to a plane that intersects perpendicularly with the center line. A point J1 is a point to which the center line of the restriction part 101b is projected to a plane that intersects perpendicularly with the center line. A point J2 is a point to which the center line of the sub-mirror drive shaft 301b (the center line of the rotation of the sub-mirror drive member 300b to the sub-mirror holder 212b) is projected to a plane that intersects perpendicularly with the center line. The three center lines corresponding to the points J0, J1, and J2 are approximately parallel mutually, and, accordingly, the points J0, J1, and J2 are projected to the same plane that intersects perpendicularly with the three center lines. FIG. 9 shows the mirror unit 200b in a state where the points J0, J1, and J2 are located on a straight line.

When the main-mirror drive shaft 205b of the main-mirror holder 202b in the state in FIG. 8 is driven by the main-mirror drive mechanism (not shown) in the minor-up direction (clockwise in FIG. 8), the mirror unit 200b changes to the minor-up state via the state in FIG. 9. In the state in FIG. 9, the connecting sleeve 302b contacts the restriction part 101b of the mirror box 100b because the sub-mirror drive member 300b is energized by the sub-minor energization member 400b. Since the energization force of the sub-minor energization spring 403b is received by the restriction part 101b in this state, it does not become a drive load. The sub-mirror holder 212b is positioned by the sub-mirror drive member 300b, and is driven in the direction to close to the main-mirror holder 202b (the direction that decreases the angle between the main-mirror holder 202b and the sub-mirror holder 212) from the state in FIG. 8.

In order to reduce the impact that occurs when the main-minor holder 202b collides with the minor-up stopper 110b, the main-minor drive mechanism applies deceleration control to the rotation of the main-mirror holder 202b in the state in FIG. 9. At this time, since inertia force acts on the sub mirror 211b, the sub-minor holder 212b tends to rotate in a direction of an arrow R around the sub-mirror rotation hole 213b. However, since the points J0, J1, and J2 are located on the straight line as shown in FIG. 9, and since the sub-mirror drive member 300b and sub-minor energization member 400b are strutted to each other, the motion of the sub-mirror holder 212b is restricted. Thereby, when the deceleration control is applied to the main-minor holder 202b, decelerating force acts on the sub-mirror holder 212b without delay.

Although the deceleration control is preferably applied to the main-mirror holder 202b at the timing when the points J0, J1, and J2 are located on the straight line as shown in FIG. 9, it may be applied at another timing. There is a gap that is required for the angle adjustment of the sub mirror 211b between the restriction part 101b and connecting sleeve 302b as shown in FIG. 7A. Accordingly, even if the deceleration control is applied to the main-mirror holder 202b in a state other than the state in FIG. 9, the deceleration of the sub-mirror holder 212b is not delayed approximately.

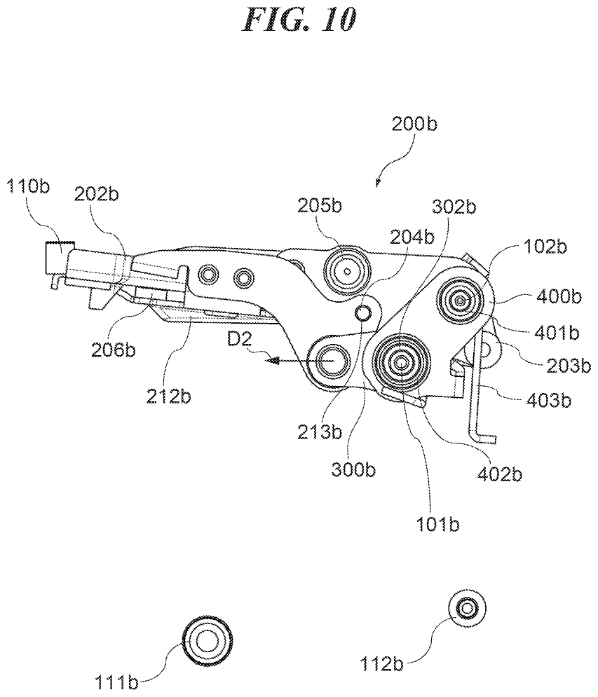

FIG. 10 is a right side view showing the mirror unit 200b in the minor-up state. When the main-mirror drive shaft 205b of the main-minor holder 202b is driven by the main-mirror drive mechanism (not shown) in the mirror-up direction from the state in FIG. 9, the mirror unit 200b changes to the mirror-up state in FIG. 10. The main-minor holder 202b is energized by the main-minor drive mechanism in the minor-up direction and contacts the mirror-up stopper 110b. The sub-minor holder 212b receives force in a direction of an arrow D2 from the sub-mirror drive member 300b that is pushed up by the sub-mirror energization member 400b. The sub-mirror holder 212b is energized by the force in the arrow D2 direction in the minor-up direction around the sub-mirror rotation hole 213b and contacts a shock absorber 206b provided in the main-minor holder 202b. Thus, when the mirror unit 200b is in the mirror-up state, the sub-mirror energization member 400b energizes the sub mirror 211b in the mirror-up direction. At this time, the connecting sleeve 302b of the sub-mirror drive member 300b is not in contact with the restriction part 101b of the mirror box 100b.

A mirror-down action is performed in the inverse order of the above-mentioned mirror-up action. That is, when the main-mirror drive shaft 205b of the main-mirror holder 202b is driven by the main-mirror drive mechanism in the mirror-down direction from the state in FIG. 10, the mirror unit 200b changes to the state in FIG. 9 and the state in FIG. 8 in order.

In order to reduce the impact that occurs when the main-mirror holder 202b collides with the mirror-up stopper 110b and the impact that occurs when the sub mirror 211b collides with the sub-minor stopper 112b, the main-mirror drive mechanism applies deceleration control to the rotation of the main-mirror holder 202b in the state in FIG. 9. At this time, since inertia force acts on the sub mirror 211b, the sub-mirror holder 212b tends to rotate in the inverse direction of the arrow R around the sub-mirror rotation hole 213b. However, since the mirror unit 200b is configured so that the points J0, J1, and J2 will be located on the straight line as shown in FIG. 9 and so that the sub-mirror drive member 300b and sub-minor energization member 400b will be strutted to each other, the motion of the sub-mirror holder 212b is restricted. Thereby, when the deceleration control is applied to the main-minor holder 202b, the decelerating force acts on the sub-minor holder 212b without delay.

Although the deceleration control is preferably applied to the main-mirror holder 202b at the timing when the state in FIG. 9 appears, it may be applied at another timing. There is a gap that is required for the angle adjustment of the sub mirror 211b between the restriction part 101b and connecting sleeve 302b as shown in FIG. 7A. Accordingly, even if the deceleration control is applied to the main-mirror holder 202b in a state other than the state in FIG. 9, the deceleration of the sub-mirror holder 212b is not delayed approximately.

As mentioned above, since the position of the sub-minor holder 212b is settled by the main-mirror holder 202b and sub-mirror drive member 300b, the sub mirror 211b is controllable without delay with respect to the control of the main-minor holder 202b. Accordingly, the mirror unit 200b lowers the impact that occurs in the sub-mirror holder 212b to reduce the mirror bound of the sub mirror 211b by controlling the drive of the main-minor holder 202b so as to lower the impact that occurs in the main-mirror holder 202b to reduce the mirror bound of the main mirror 201b.

Moreover, the sub-mirror holder 212b is energized by the sub-mirror energization member 400b in the mirror-down direction when the sub-mirror holder 212b is at the mirror-down position and is energized in the mirror-up direction when the sub-mirror holder 212b is at the mirror-up position. The energization force of the sub-mirror energization member 400b does not become a drive load during the rotation (movement) of the sub-mirror holder 212b between the mirror-up position and mirror-down position. Furthermore, since the mirror unit 200b is not configured so that the energization force of the sub-mirror energization member 400b is once increased and then decreased, its load fluctuation is also small. Such a configuration enables to obtain high driving stability with the simple control to the mirror unit 200b.

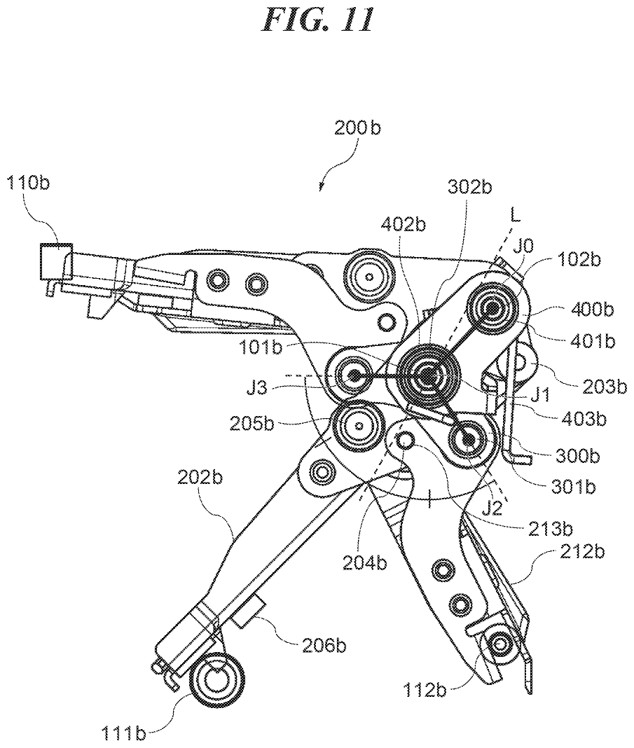

Next, the arrangement of the sub-mirror energization member 400b will be described. FIG. 11 is a right side view showing the mirror-down state and minor-up state of the mirror unit 200b in an overlapped fashion. The points J0, J1, and J2 are identical to the points described by referring to FIG. 9, respectively. A point J3 is a point to which the center line of the sub-mirror drive shaft 301b of the sub-mirror drive member 300b is projected to a plane that intersects perpendicularly with the center line. The four center lines corresponding to the points J0, J1, J2, and J3 are approximately parallel mutually, and accordingly, the points J0, J1, J2, and J3 are projected to the same plane that intersects perpendicularly with the four center lines.

When the mirror unit 200b is in the mirror-down state, the angle adjustment range of the sub-mirror holder 212b to the main-minor holder 202b becomes larger as the angle (angle J0J1J2) between the sub-mirror energization member 400b and sub-mirror drive member 300b is closer to the right angle. On the contrary, when the mirror unit 200b is in the mirror-down state, the angle adjustment range of the sub-mirror holder 212b to the main-mirror holder 202b becomes narrow as the angle (angle J0J1J2) between the sub-mirror energization member 400b and sub-mirror drive member 300b is closer to 180 degrees.

Generally, the angle adjustment in the case where the sub-mirror holder 212b (sub mirror 211b) is in the mirror-down position is needed for guiding light to the focus detection unit 4 with high accuracy. In the meantime, since the mirror-up action is sufficient to retract the sub-minor holder 212b from the photographing light path, high accuracy is not needed for the angle of the sub-mirror holder 212b (sub mirror or 211b) at the mirror-up position. Accordingly, it is preferable that the rotatable range of the sub-mirror holder 212b at the mirror-down position be larger than the rotatable range at the minor-up position.

In order to achieve such a configuration, it is preferable that the angle (angle J0J1J2) between the sub-mirror energization member 400b and sub-mirror drive member 300b be close to the right angle when the mirror unit 200b is in the mirror-down state. In other words, it is preferable that the supporting hole 401b (point J0) of the sub-minor energization member 400b in the mirror-down state be arranged nearer to the sub-minor drive member 300b than a median line (a broken line L in FIG. 11) of a rotatable angle (angle J2J1J3) of the sub-minor drive member 300b.

Although the preferable embodiments of the present invention have been described above, the present invention is not limited to these embodiments, and various deformations and variations are available within the scope of the present invention. For example, the rotatable range of the sub-minor energization member 400b is restricted by the backlash between the connecting sleeve 302b of the sub-minor drive member 300b and the restriction part 101b of the mirror box 100b. A configuration that directly restricts the sub-minor energization member 400b may be provided in the mirror box 100b instead. This improves durability because the sliding parts, such as the connecting sleeve 302b and restriction part 101b, that slide during driving of the mirror unit 200b are eliminated.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-200948, filed Oct. 25, 2018, which is hereby incorporated by reference herein in its entirety.

What is claimed is:

1. A mirror drive device comprising:
a first holding member that holds a first mirror;
a supporting member that rotatably supports the first holding member;
a second holding member that holds a second mirror and is rotatably supported by the first holding member; and
a drive member that is rotatably supported by the supporting member and is rotatably connected with the second holding member,
wherein rotation of one of the first holding member and the second holding member interlocks with rotation of the other through rotation of the drive member.

2. The mirror drive device according to claim 1, wherein a position of a rotation center of the drive member to the supporting member is adjustable on a circular arc around a rotation axis of the first holding member.

3. A mirror drive device comprising:
a first holding member that holds a first mirror;
a supporting member that rotatably supports the first holding member;
a second holding member that holds a second mirror and is rotatably supported by the first holding member;
an energization member that is rotatably supported by the support member;
a drive member that is rotatably connected to the energization member and is rotatably connected with the second holding member; and
a restriction part that is provided in the support member and restricts a rotatable range of the energization member,
wherein the energization member is energized in one of two rotatable directions, and
wherein rotation of one of the first holding member and the second holding member interlocks with rotation of the other through rotation of the drive member.

4. The mirror drive device according to claim 3, wherein the restriction part is a shaft,
wherein the drive member has a first cylindrical portion in which the shaft is inserted,
wherein the energization member has a second cylindrical portion that fits to an outer periphery of the first cylindrical portion,
wherein a predetermined gap is provided between an outer periphery of the shaft and an inner periphery of the first cylindrical portion, and
wherein the energization member is rotatable within a range of the predetermined gap.

5. The mirror drive device according to claim 4, wherein a center line of rotation of the energization member, a center line of the shaft, and a center line of rotation of the second holding member are approximately parallel mutually,
wherein three points to which the center lines are projected to a plane that approximately intersects perpendicularly with the center lines are located on a straight line during rotation of the first mirror between a first position in a photographing light path and a second position outside the photographing light path.

6. The mirror drive device according to claim 5, further comprising a drive mechanism that rotates the first holding member between the first position and the second position,
wherein the drive mechanism applies deceleration control to rotation of the first holding member in a state where the three points are located on the straight line.

7. The mirror drive device according to claim 5, wherein a rotation center of the energization member in a state where the first holding member is in the first position is arranged nearer to the drive member than a median line of a rotatable angle of the drive member during the rotation of the first holding member between the first position and the second position.

8. An image pickup apparatus comprising:
a focus detection sensor;
an optical finder;
a mirror unit that is provided with a first mirror that reflects a light beam entered through a photographing optical system to the optical finder and a second mirror that reflects a light beam transmitted through the first mirror toward the focus detection sensor; and
a mirror drive device comprising:
a first holding member that holds the first mirror;
a supporting member that rotatably supports the first holding member;
a second holding member that holds the second mirror and is rotatably supported by the first holding member; and
a drive member that is rotatably supported by the supporting member and is rotatably connected with the second holding member,
wherein rotation of one of the first holding member and the second holding member interlocks with rotation of the other through rotation of the drive member.

9. An image pickup apparatus comprising:
a focus detection sensor;
an optical finder;
a mirror unit that is provided with a first mirror that reflects a light beam entered through a photographing optical system to the optical finder and a second mirror that reflects a light beam transmitted through the first mirror toward the focus detection sensor; and
a mirror drive device comprising:
a first holding member that holds the first mirror;
a supporting member that rotatably supports the first holding member:
a second holding member that holds the second mirror and is rotatably supported by the first holding member;
an energization member that is rotatably supported by the support member;
a drive member that is rotatably connected to the energization member and is rotatably connected with the second holding member; and
a restriction part that is provided in the support member and restricts a rotatable range of the energization member,
wherein the energization member is energized in one of two rotatable directions, and
wherein rotation of one of the first holding member and the second holding member interlocks with rotation of the other through rotation of the drive member.
